(19) United States
(12) Patent Application Publication
(10) Pub. No.: US 2005/0172563 A1
(43) Pub. Date: Aug. 11, 2005

(54) Drive device for suspended members

(75) Inventor: Masahiko Komoda, Aichi-ken (JP)

Correspondence Address: CARSTENS YEE & CAHOON, LLP, P O BOX 802334, DALLAS, TX, 75380, US

(73) Assignee: ASMO CO., LTD., Shizuoka-ken (JP)

(21) Appl. No.: 11/022,734

(22) Filed: Dec. 27, 2004

(30) Foreign Application Priority Data
Feb. 9, 2004 (JP) 2004-032717

(51) Int. Cl. E05F 11/00

(52) U.S. Cl. 49/358; 49/409

(57) ABSTRACT

An electric curtain device of the present invention includes a pair of running members and a pair of chargers arranged at opposed ends of a curtain rail. The running members are movable along the curtain rail and support a pair of curtains, respectively, in a suspended state. Each of the running members includes a supersonic motor and is moved along the curtain rail when actuated by a supersonic motor. Further, each running member has a battery and a driver. The electric curtain device is relatively easy to handle. Further, the appearance of the device is improved without requiring machining of the curtain rail.

### BACKGROUND OF THE INVENTION

The present invention relates to drive devices for moving a suspended member, such as a curtain along a rail.

Japanese Laid-Open Patent Publication No. 2001-37622 describes a drive device for a suspended member. A running member is movable along a curtain rail and supports a curtain, which is a suspended member, in a suspended state. More specifically, the running member is provided with an actuator such as a motor and is moved along the rail by drive force of the actuator. The drive device is operated through, for example, manipulation of a remote controller switch, such that the curtain is selectively extended or folded.

However, the prior art drive device needs a line for supplying power to the actuator, or a power cable, which is difficult to handle. Also, the curtain rail must be machined in a particular manner for preventing exposure of the cable to the exterior, in order to improve the appearance of the curtain rail. Alternatively, a particular curtain rail must be provided for the drive device.

### SUMMARY OF THE INVENTION

Accordingly, it is an objective of the present invention to provide a suspended member drive device that is relatively easy to handle and has improved appearance without being machined in a particular manner.

To achieve the foregoing and other objectives and in accordance with the purpose of the present invention, the invention provides a drive device for a suspended member that is suspended from a rail. The drive device includes a running member, a battery, and a charger. The running member has an actuator. The running member is movable along the rail and supports the suspended member in a suspended state. The running member is moved along the rail by drive force of the actuator. The battery is provided in the running member. The charger charges the battery when the running member is at a location along a path of movement of the running member.

The present invention also provides another drive device for a suspended member that is suspended from a rail. The drive device includes a running member, a batter, and a solar battery. The running member has an actuator. The running member is movable along the rail and supports a suspended member in a suspended state. The running member is moved along the rail by drive force of the actuator. The battery is provided in the running member. The solar battery is supported by the running member for charging the battery.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view showing a main portion of a running member of an electric curtain device according to a first embodiment of the present invention;

FIG. 2 is a side view showing the running member of the electric curtain device;

FIG. 3 is a partially cross-sectional front view, with a part cut away, showing the running member of the electric curtain device;

FIG. 4 is a perspective view showing the running member of the electric curtain device;

FIG. 5 is a front view showing the electric curtain device;

FIG. 6 is a front view showing the electric curtain device;

FIG. 7 is a schematic view showing an end of a curtain rail;

FIG. 8 is a schematic view showing a curtain rail of the second embodiment as viewed from above;

FIG. 9 is a view explaining rail length data and curtain extending/folding speed; and

FIG. 10 is a perspective view showing a running member of an electric curtain device of a modified embodiment.

### DETAILED DESCRIPTION OF THE PREFERRED EMBODIMENTS

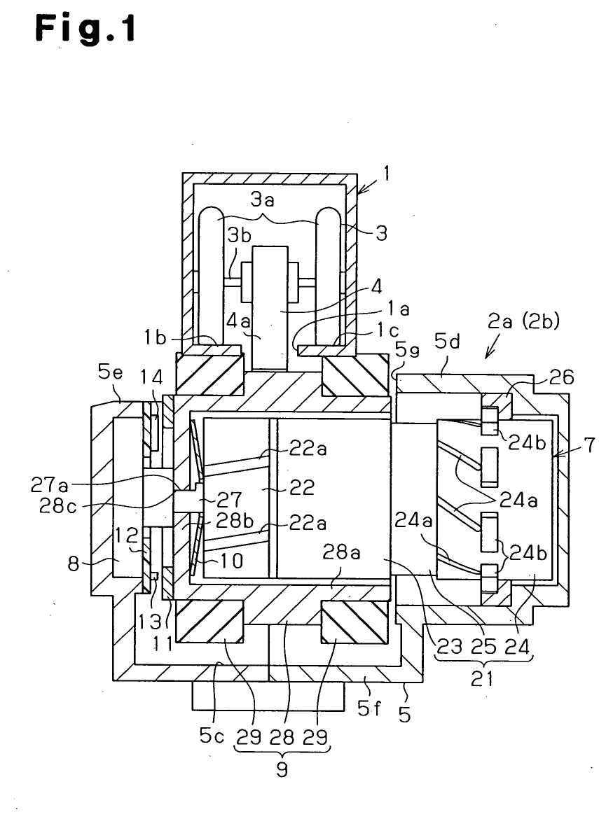

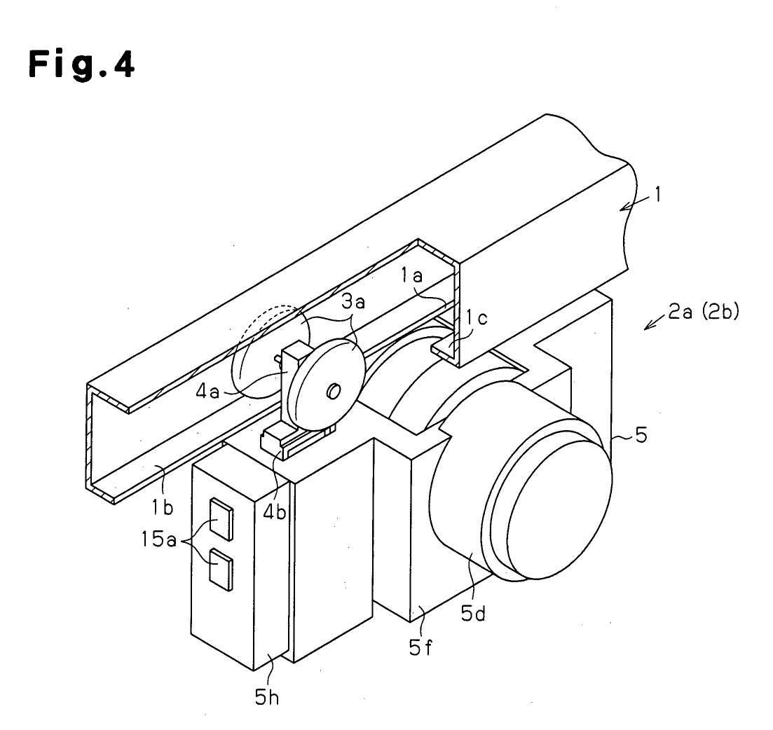

A first embodiment of an electric curtain device, or a suspended member drive device, according to the present invention will hereafter be described with reference to FIGS. 1 to 7.

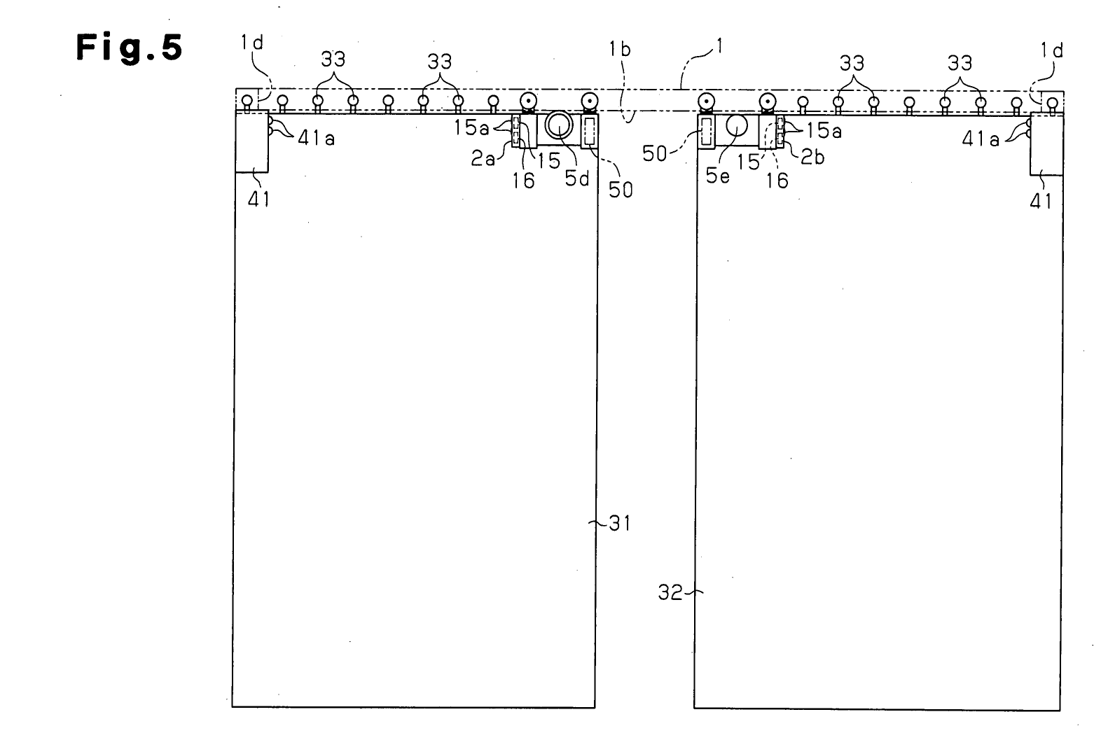

Referring to FIGS. 1 to 4, a curtain rail 1 is shaped substantially like a hollow square pole. A slit la is defined in a lower side of the curtain rail 1 and extends along the longitudinal direction of the curtain rail 1. A pair of opposing support portions 1b, 1c are formed by a pair of lower wall sections of the curtain rail 1. The slit la is located between the support portions 1b, 1c. As shown in FIG. 5, a pair of running members 2a, 2b is provided in the curtain rail 1 in a manner movable along the curtain rail 1.

Each of the running members 2a, 2b includes a pair of runners 3, a pair of connecting members 4, a casing 5, a pair of compression springs 6, a supersonic motor 7 serving as an actuator, a bearing 8, a rotary member 9, a disc spring 10, a sensor magnet 11, a base plate 12, a Hall element 13, a controller (an IC) 14, a battery 15 shown in FIG. 3, and a driver 16.

Each of the runners 3 has a pair of rolling bodies 3a and a support shaft 3b connecting the rolling bodies 3a to each other. The rolling bodies 3a are supported in a rollable manner by the corresponding one of the support portions 1b, 1c of the curtain rail 1. This structure allows each runner 3 to contact the curtain rail 1 for supporting the corresponding running member 2a, 2b in a suspended state. The rolling bodies 3a are formed of rubber. The runners 3 are arranged in the longitudinal direction of the curtain rail 1.

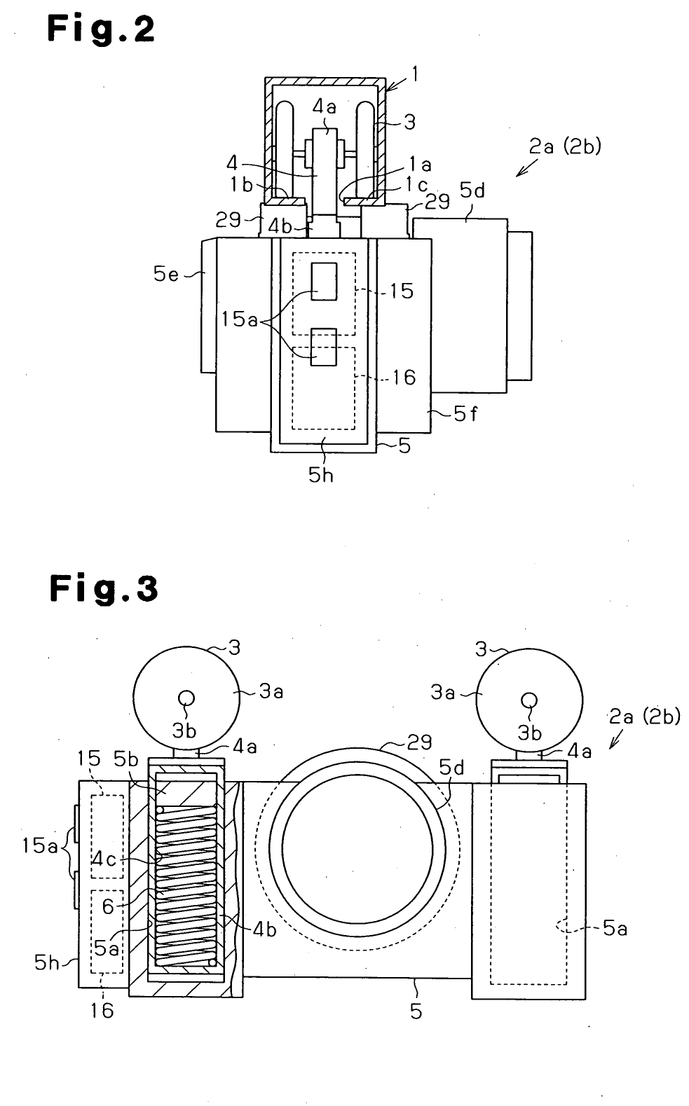

The support shaft 3b of each runner 3 is rotatably supported by the corresponding connecting member 4. Each connecting member 4 includes a support portion 4a and an extended portion 4b. As shown in FIG. 2, the support portion 4a of each connecting member 4 supports the support shaft 3b of the corresponding runner 3 and extends through the slit 1a to a position below the curtain rail 1. Referring to FIG. 3, the extended portion 4b of each connecting member 4 extends further downward with respect to the associated support portion 4a, and has an accommodating recess 4c. Each support portion 4a is supported by the associated extended portion 4b to be rotatable about the vertical axis.

With reference to FIG. 3, a pair of insertion holes 5a is defined at opposite ends of the casing 5 in the longitudinal direction of the curtain rail 1. The extended portion 4b of each connecting member 4 is inserted vertically in the corresponding one of the insertion holes 5a from above. An inner extended portion 5b is located in an upper portion of each insertion hole 5a. Each of the inner extended portions 5b is received in the associated accommodating recess 4c when the extended portion 4b of each connecting member 4 is inserted in the associated insertion hole 5a. Each of the compression springs 6 is clamped, in a compressed state, between the bottom surface of the corresponding inner extended portion 5b and the upper side of the bottom of the associated accommodating recess 4c. Each of the inner extended portions 5b is formed of two pieces. Each piece is formed integrally with one of two molded bodies forming the casing 5. More specifically, the inner extended portions 5b and the compression springs 6 are disposed in the corresponding accommodating recesses 4c when the molded bodies are joined together. Accordingly, the casing 5 is movable in the vertical direction and is constantly urged by the compression springs 6 toward the runners 3.

As illustrated in FIG. 1, an accommodating recess 5c having an upper opening is defined in each casing 5. The accommodating recess 5c includes a stator accommodating portion 5d, a bearing accommodating portion 5e, and an intermediate accommodating portion 5f. Referring to FIGS. 1 and 2, the stator accommodating portion 5d has a circumferential wall and a sidewall, projecting forward by a relatively large amount rightward as viewed in the drawings, or in a direction perpendicular to the longitudinal direction of the curtain rail 1. The bearing accommodating portion 5e also has a circumferential wall and a sidewall, projecting rearward by a relatively small amount leftward as viewed in FIGS. 1 and 2, or in the direction opposed to the projecting direction of the stator accommodating portion 5d. The intermediate accommodating portion 5f is defined between the stator accommodating portion 5d and the bearing accommodating portion 5e, thus connecting the stator accommodating portion 5d and the bearing accommodating portion 5e to each other. An opening 5g is defined in an upper wall of the intermediate accommodating portion 5f.

With reference to FIG. 1, the supersonic motor 7 is a “bolted Langevin type” having a substantially columnar shape and includes a stator 21 and a rotor 22. The stator 21 is vibrated when supplied with high frequency voltage. The rotor 22 is pressed against the stator 21 and is rotated in correspondence with vibration of the stator 21.

The stator 21 includes a first metal block 23 and a second metal block 24, which are substantially cylindrical, as well as a piezoelectric element 25. A plurality of converting slits 24a and a plurality of securing projections 24b are arranged along the outer circumferential surface of the second metal block 24. The converting slits 24a generate torsional vibration in accordance with excitation of longitudinal vibration. More specifically, the converting slits 24a are aligned in the circumferential direction in a manner slanted with respect to the axis of the second metal block 24. Each of the securing projections 24b projects radially from the circumferential surface of the second metal block 24. The piezoelectric element 25 is shaped substantially like a. disk and includes a non-illustrated electrode plate for generating high frequency voltage. The first and second metal blocks 23, 24 are fastened to each other with the piezoelectric element 25 in between by a non-illustrated bolt extending axially through the metal blocks 23, 24 and the piezoelectric element 25. The securing projections 24b of the second metal block 24 are secured to the stator accommodating portion 5d by means of a securing member 26. The stator 21 is thus secured to the casing 5. Further, the second metal block 24 and the piezoelectric element 25 of the stator 21 are accommodated in the stator accommodating portion 5d, while the first metal block 23 is accommodated in the intermediate accommodating portion 5f.

The rotor 22 is substantially cylindrical in shape. A plurality of converting slits 22a are defined in the outer circumferential surface of the rotor 22 for generating torsional vibration in accordance with excitation of longitudinal vibration. The converting slits 22a are aligned in the circumferential direction of the rotor 22 in a manner slanted with respect to the axis of the rotor 22. A rotary shaft 27 extends through the middle portion of the rotor 22. The rotary shaft 27 projects from the rotor 22 and is prohibited from rotating relative to the rotor 22 but permitted to move along the axis of the rotor 22. The distal end of the rotary shaft 27 is rotatably supported by a bearing 8 retained in the bearing accommodating portion 5e. An engaging portion 27a is formed in an intermediate portion of the rotary shaft 27 by cutting a section of the rotary shaft 27, which has a circular cross-section. The rotary member 9 is engaged with the engaging portion 27a such that the rotary member 9 is prohibited from rotating relative to the rotary shaft 27 but permitted to move along the axis of the rotor 22.

More specifically, the rotary member 9 includes a tubular member 28 and a pair of output transmitting members 29 each serving as an output transmitting portion securely fitted to the tubular member 28. The tubular member 28 is formed by a tubular portion 28a and a sidewall 28b. The sidewall 28b substantially closes an opening of the tubular portion 28a. A non-circular engaging hole 28c is defined at the middle of the sidewall 28b in correspondence with the engaging portion 27a. The rotary member 9 is supported by the engaging portion 27a engaged with the engaging hole 28c such that the rotary member 9 is prohibited from rotating relative to the rotary shaft 27 but permitted to rotate along the axis of the rotor 22. Further, leftward movement of the rotary member 9 as viewed in FIG. 1 is restricted due to contact between the sidewall 28b and the bearing 8. The tubular member 28 accommodates most of the rotor 22 and the first metal block 23. The disc spring 10 is clamped, in a compressed state, between the sidewall 28b and the rotor 22. Accordingly, the rotor 22 is pressed against the left end face of the stator 21 by the disc spring 10.

The output transmitting members 29 are formed of rubber and are disposed at opposite ends of the tubular portion 28a. A portion of each output transmitting member 29 is exposed from the opening 5g to the exterior. Further, each output transmitting member 29 is pressed against the lower side of the corresponding support portion 1b, 1c of the curtain rail 1.

With reference to FIG. 1, the sensor magnet 11 is formed in an annular shape and is secured to an outer surface of the sidewall 28b of the tubular member 28. The sensor magnet 11 includes N poles and S poles that are formed alternately along the circumferential direction of the sensor magnet 11.

The base plate 12 has an annular shape and is secured to the open side of the bearing accommodating portion 5e, such that the base plate 12 faces the sidewall 28b of the tubular member 28. The Hall element 13 and the controller 14 are attached to the base plate 12. The Hall element 13 is arranged to face the sensor magnet 11.

As shown in FIGS. 2 to 4, an extended accommodating portion 5h is formed at a left end of the casing 5. Referring to FIGS. 2 and 3, the extended accommodating portion 5h accommodates the battery 15 and the driver 16. A pair of battery terminals 15a is disposed at an end of the extended accommodating portion 5h in the longitudinal direction of the curtain rail 1 in a state exposed to the exterior.

In each of the running members 2a, 2b, the Hall element 13 and the battery 15 are electrically connected to the controller 14. The controller 14 and the battery 15 are electrically connected to the driver 16. The driver 16 is electrically connected to the piezoelectric element 25. In the first embodiment, the sensor magnet 11, the Hall element 13, and the controller 14 define a position acquiring means for acquiring the positions of the running members 2a, 2b on the curtain rail 1. Further, the controller 14 and the driver 16 define a control means.

The running members 2a, 2b are deployed as opposed to each other on the curtain rail 1. More specifically, referring to FIG. 5, the running member 2a, located on the left side as viewed in the drawing, is arranged such that the stator accommodating portion 5d is visible at the rear of the curtains 31, 32. In contrast, referring to FIG. 5, the running member 2b, located on the right side as viewed in the drawing, is arranged such that the bearing accommodating portion 5e is visible at the rear of the curtains 31, 32. In other words, the running member 2a on the left side as viewed in FIG. 5 is arranged such that the stator accommodating portion 5d is visible from the window side of the curtains 31, 32, which separate the window side from the interior of the room. However, the running member 2b on the right side is arranged such that the bearing accommodating portion 5e is visible from the window side of the curtains 31, 32.

Each of the running members 2a, 2b includes a non-illustrated hook portion for supporting the corresponding curtain 31, 32 in a suspended state. More specifically, the curtain rail 1 includes a plurality of runners 33 and the running members 2a, 2b for supporting the corresponding curtains 31, 32 in a suspended state at positions corresponding to predetermined intervals. Each running member 2a, 2b is followed by the corresponding, aligned runners 33. Each of the runners 33 does not include a specific drive source but is movable by external force. In other words, the curtain 31 on the left is supported in a suspended state by the running member 2a on the left and the associated runners 33 at the positions corresponding to the predetermined intervals. Likewise, the curtain 32 on the right is supported in a suspended state by the running member 2b on the right and the associated runners 33 at the positions corresponding to the predetermined intervals.

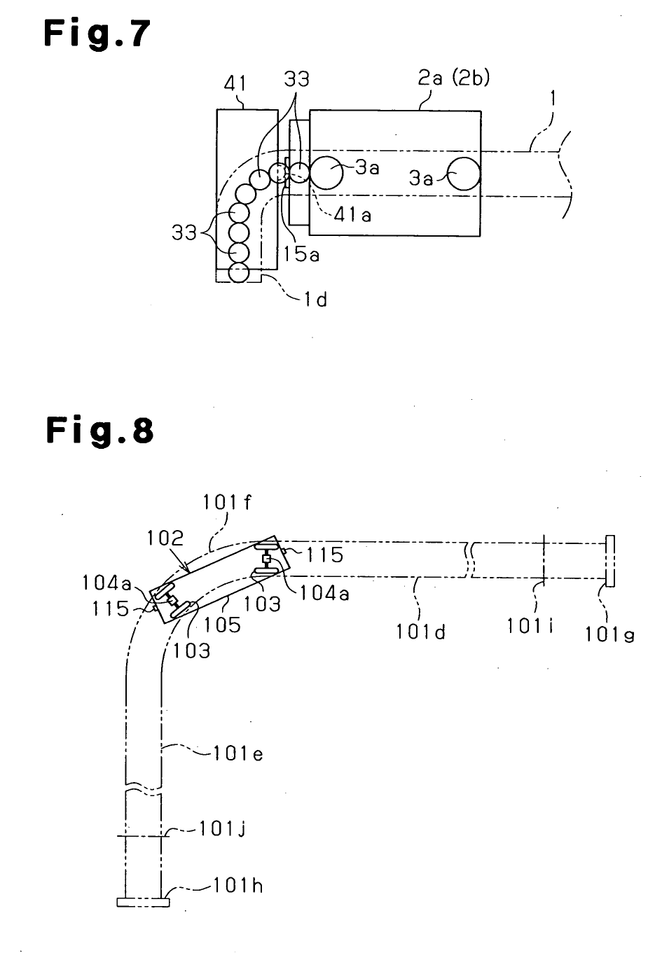

As shown in FIG. 7, a pair of runner accommodating portions 1d are formed at opposed, longitudinal ends of the curtain rail 1 for accommodating the corresponding runners 33. Each of the runner accommodating portions 1d is bent to be perpendicular to the longitudinal direction of the curtain rail 1.

With reference to FIGS. 5 to 7, a pair of chargers 41 are secured to opposed, longitudinal ends of the curtain rail 1 below the opposed runner accommodating portions 1d. The running members 2a, 2b and the chargers 41 form the electric curtain device. Each of the chargers 41 is located along the line extended along the moving direction of the corresponding running member 2a, 2b. Each charger 41 includes a pair of charging terminals 41a. Each of the charging terminals 41a is exposed to the exterior at the position corresponding to the associated battery terminal 15a. Each charging terminal 41a can be selectively retracted or projected and is urged to the exterior in one direction of the charger 41 by a non-illustrated urging means. When the running members 2a, 2b reach the corresponding ends of the curtain rail 1 and approach the chargers 41, the charging terminals 41a are electrically connected to the battery terminals 15a of the corresponding batteries 15. In this state, the chargers 41 charge the corresponding batteries 15. Further, when the running members 2a, 2b separate from the chargers 41, the charging terminals 41a are electrically disconnected from the corresponding battery terminals 15a.

In the electric curtain device, a high frequency voltage is generated by the drivers 16, which are connected to the associated batteries 15, through manipulation of, for example, a remote controller switch. More specifically, if the high frequency voltage at a first driving frequency is supplied to the piezoelectric element 25 of each running member 2a, 2b, longitudinal vibration is produced in the piezoelectric element 25. The first driving frequency corresponds to a frequency of a predetermined range relatively close to a first resonance frequency f1 of each supersonic motor 7. In response to the longitudinal vibration of the piezoelectric element 25, torsional vibration is caused in the vicinity of the converting slits 24a of the corresponding stator 21. At this stage, the vibration produced at the stator 21 corresponds to coupling vibration produced by combining the torsional vibration with the longitudinal vibration. The corresponding rotor 22 is thus rotated in a normal direction by buoyancy generated by the longitudinal vibration element of the stator 21 and driving force produced by the torsional vibration element of the stator 21. Such operation is referred to as the stator main mode. As a result, each rotary member 9 is rotated together with the corresponding rotor 22 with the curtain rail 1 held between the rotary members 9 and the runners 3 such that the running members 2a, 2b are moved toward each other, or toward the middle of the entire curtain rail 1 with respect to the longitudinal direction. In this manner, the two curtains 31, 32 are extended to cover the windows.

If the high frequency voltage at a second driving frequency is supplied from the driver 16 to each piezoelectric element 25 in correspondence with the manipulation of the remote controller switch, longitudinal vibration is produced in the piezoelectric element 25. The second driving frequency corresponds to a frequency of a predetermined range relatively close to a second resonance frequency f2 of each supersonic motor 7. In response to the longitudinal vibration of the piezoelectric element 25, torsional vibration is generated in the vicinity of the converting slits 24a of the corresponding stator 21. At this stage, the vibration at the stator 21 corresponds to coupling vibration produced by combining the torsional vibration, which is relatively small and is caused in a direction opposed to that of the torsional vibration in the stator main mode, with the longitudinal vibration.

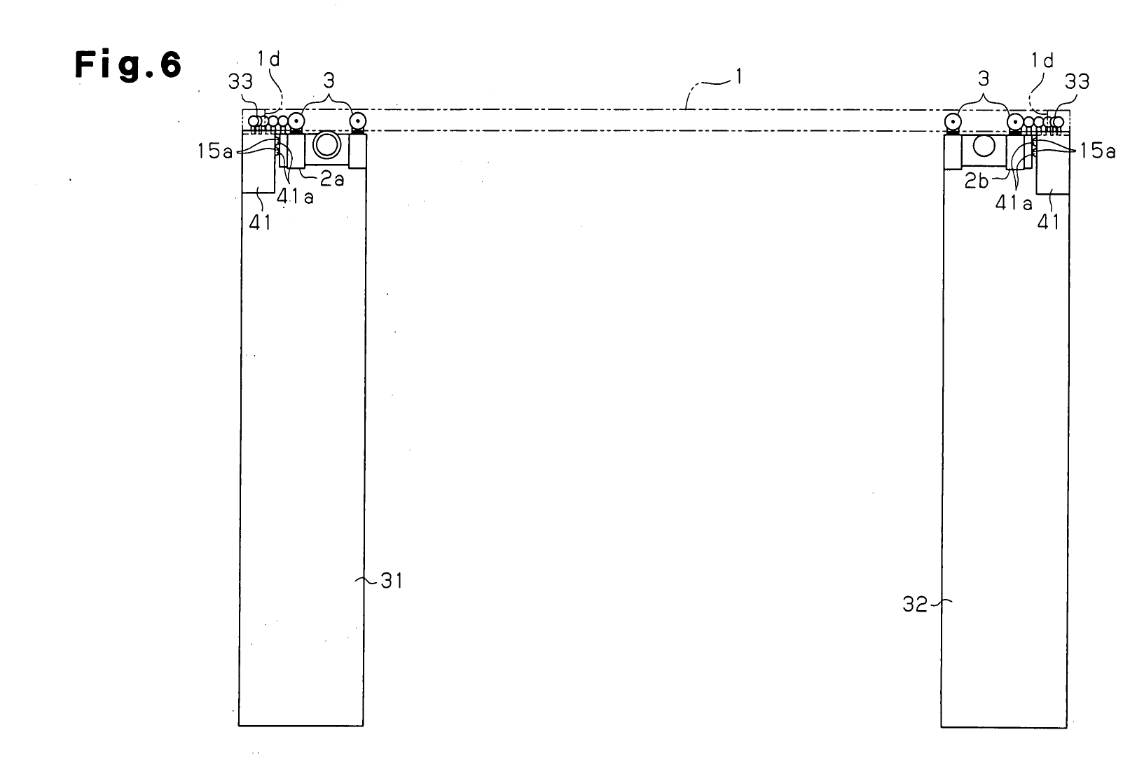

The resonance frequency of each rotor 22 is set in correspondence with the second driving frequency. Accordingly, in resonance with the coupling vibration, relatively large torsional vibration is generated in the vicinity of the converting slits 22a of each rotor 22. In this state, the torsional vibration generated by the slits 22a of the rotor 22 causes the rotor 22 to rotate in an opposite direction, or a direction opposed to that of the stator main mode. Thus, each rotor 22 is rotated in a reverse direction by buoyancy caused by the longitudinal vibration element of the corresponding stator 21 and thrust force produced by the torsional vibration element of the stator 21, as well as the torsional vibration element of the rotor 22. Such operation is referred to as rotor main mode. As a result, the running members 2a, 2b are moved away from each other, or toward the corresponding ends of the curtain rail 1. In this manner, as illustrated in FIG. 6, the two curtains 31, 32 are folded together at the corresponding ends of the curtain rail 1 such that the windows are exposed.

The electric curtain device of this embodiment acquires the position of each running member 2a, 2b on the curtain rail 1 by means of the position acquiring means, or, more specifically, the sensor magnets 11, the Hall elements 13, and the controllers 14. Further, the electric curtain device alters the frequency of the high frequency voltage supply for each supersonic motor 7 by means of the control means, more specifically, the controllers 14 and the drivers 16, in correspondence with the acquired position of the corresponding running member 2a, 2b.

When each running member 2a, 2b is moved toward the corresponding end of the curtain rail 1, the control means changes the frequency of the high frequency voltage supply away from the second resonance frequency f2 if it is determined that the running member 2a, 2b has reached the ends. Accordingly, the output of each supersonic motor 7 is reduced. The speed of each running member 2a, 2b is thus lowered, such that an impact caused by contact between the running member 2a, 2b and the corresponding charger 41 is suppressed when the running member 2a, 2b stops at the corresponding end of the curtain rail 1. Further, with the running members 2a, 2b stopped at the corresponding ends of the curtain rail 1, the charger elements 41a are each temporarily retracted in the charger 41 against the aforementioned urging means (not shown). Immediately thereafter, each charger element 41a is pressed against the battery terminal 15a by the corresponding urging means and is thus electrically connected to the battery terminal 15a. In this manner, when the curtains 31, 32 are folded, each charger 41 is electrically connected to the corresponding battery 15 such that the battery 15 is charged automatically. Further, when the running members 2a, 2b stop at the corresponding ends of the curtain rail 1, the high frequency voltage supply is stopped. However, even immediately after the high frequency voltage supply to the supersonic motors 7 is stopped, the rotor 22 is not rotated in the reverse direction by the force of the urging means of the charger element 41a, but is maintained as stopped. Accordingly, each running member 2a, 2b is prevented from being pushed back by the urging means of the charger element 41a, or, each battery terminal 41a is prevented from being released from the contact with the associated battery terminal 15a.

The first embodiment has the following advantages.

Each of the running members 2a, 2b includes the battery 15. The chargers 41 are provided at the opposed ends of the curtain rail 1. This structure enables the electric curtain device to charge the batteries 15 of the running members 2a, 2b by the chargers 41, allowing the running members 2a, 2b to be moved by the power of the corresponding batteries 15. It is thus unnecessary to connect an external power line to the running members 2a, 2b. In other words, unlike the conventional electric curtain device, the electric curtain device of the first embodiment does not need a power line. The electric curtain device is thus relatively easy to handle when, for example, the device is installed. Also, the appearance of the electric curtain device of the illustrated embodiment can be improved without providing decoration for preventing the power line from being exposed to the exterior.

The chargers 41 are located at the ends of the curtain rail 1. This improves the appearance of the curtain rail 1, as compared to the case in which the chargers 41 are disposed at the middle of the curtain rail 1. Further, when the running members 2a, 2b reach the corresponding ends of the curtain rail 1, the charging terminals 41a of the chargers 41 are pressed against the associated battery terminals 15a of the batteries 15 by using the drive force for the running members 2a, 2b. Accordingly, the charging terminals 41a are relatively easily brought into contact with the associated battery terminals 15a when the running members 2a, 2b reach the corresponding ends of the curtail rail 1.

When the running members 2a, 2b reach the corresponding ends of the curtain rail 1, the charging terminals 41a of the chargers 41 are electrically connected to the battery terminals 15a of the associated batteries 15. The chargers 41 thus charge the batteries 15. Further, if the running members 2a, 2b are moved separately from the corresponding ends of the curtain rail 1, the charging terminals 41a are electrically disconnected from the associated battery terminals 15a. Accordingly, the batteries 15 are automatically charged when the running members 2a, 2b reach the corresponding ends of the curtain rail 1.

In the first embodiment, the running members 2a, 2b are each actuated by the supersonic motor 7. This reduces noise caused by operation, as compared to the case in which a DC motor is employed for actuating the running members 2a, 2b. Also, since each supersonic motor 7 produces a relatively great torque, the electric curtain device of the first embodiment does not need a deceleration mechanism. Further, since each of the running members 2a, 2b includes the driver 16, the high frequency voltage can be generated separately for each of the running members 2a, 2b. This makes it possible to supply the high frequency voltage at a suitable frequency in correspondence with each of the supersonic motors 7.

In the first embodiment, the electric curtain device acquires the position of each running member 2a, 2b on the curtain rail 1 by means of the position acquiring means. The frequency of the high frequency voltage supplied to the associated supersonic motor 7 is thus altered by the control means in correspondence with the acquired position. That is, the output of each supersonic motor 7 is changed depending on the acquired position of the associated running member 2a, 2b. Thus, unlike the case in which the supersonic motor 7 generates a constant output in response to the high frequency voltage supplied at a constant frequency, the output transmitting members 29 of the running members 2a, 2b are prevented from rotating in an idle manner continuously after the running members 2a, 2b are stopped at the corresponding ends of the curtain rail 1. Further, the electric curtain device of the first embodiment is capable of suppressing the impact caused by the running members 2a, 2b when stopped at the ends of the curtain rail 1.

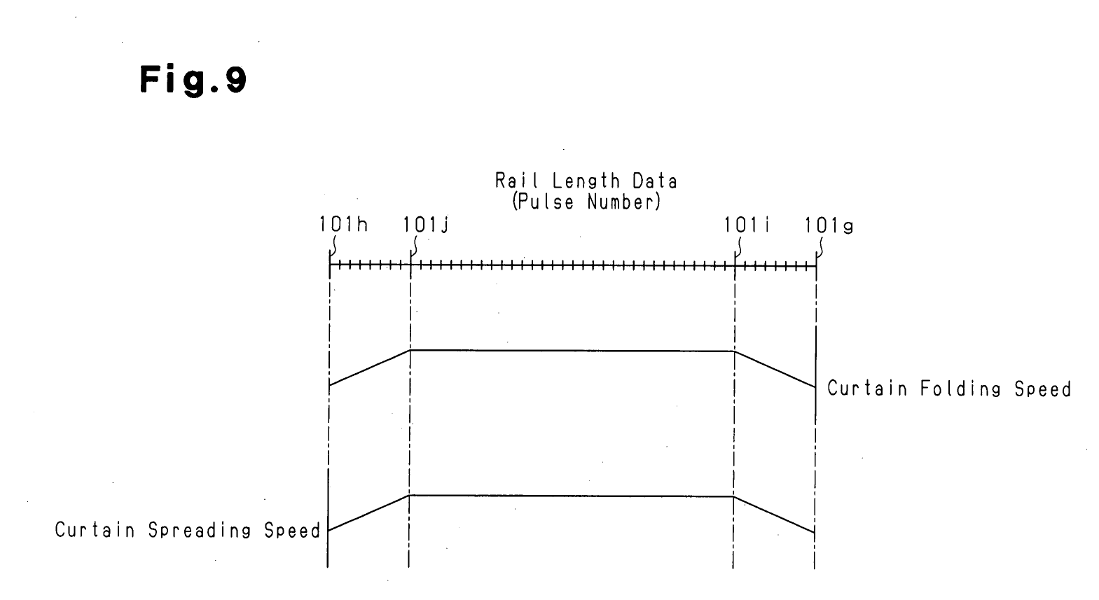

Hereafter, with reference to FIGS. 8 to 9, a second embodiment of an electric curtain device according to the present invention will be described. Mainly, the differences from the first embodiment will be discussed. In the second embodiment, the components that are the same as those in the first embodiment are assigned reference numerals formed by adding 100 to the corresponding numerals in the first embodiment, and the description of those components is omitted in the second embodiment.

As shown in FIG. 8, the curtain rail 101 includes two linear sections 101d, 101e and a curved section 101f. The linear sections 101d, 101e extend perpendicular to each other. The curved section 101f is curved in an arched manner for connecting the linear sections 101d, 101e to each other. A running member 102 is installed in the curtain rail 101 in a manner movable along the curtain rail 1. The running member 102 includes a pair of switches 115. The switches 115 are provided at opposed ends of the casing 105.

The Hall element 113 and the switches 115 are electrically connected to the controller 114. The controller 114 and the piezoelectric element 125 are connected to a non-illustrated external power supply device through a non-illustrated feeder. The controller 114 and the external power supply device define a control means. Also, the sensor magnet 111, the Hall element 113, the controller 114, and the external power supply device form an initial setting means.

The running member 102 includes a non-illustrated hook portion for supporting a non-illustrated curtain in a suspended state. More specifically, the curtain rail 101 includes a plurality of runners (not shown) for supporting the curtain in a suspended state at positions corresponding to predetermined intervals. The runners and the running member 102 are attached to the curtain rail 101. The running member 102 is followed by the aligned runners. Each of the runners does not include a specific drive source but is movable by external force.

In the electric curtain device, if a high frequency voltage at a first driving frequency is supplied from the external power supply device to the piezoelectric element 125 of the running member 102, the running member 102 moves toward the right end 101g of the curtain rail 101. In this manner, the curtain is extended to cover the corresponding window.

If the high frequency voltage at a second driving frequency is supplied from the external power supply device to each piezoelectric element 125 of the running member 102 in correspondence with manipulation of the remote controller switch, the running member 102 moves toward the left end 101h of the curtain rail 101. In this manner, the curtain is folded such that the corresponding window is exposed.

The electric curtain device of this embodiment acquires the position of the running member 102 on the curtain rail 101 by means of the position acquiring means, or, more specifically, the sensor magnet 111, the Hall element 113, and the controller 114. Further, the electric curtain device alters the frequency of the high frequency voltage supplied to the supersonic motor 107 by means of the control means, or, more specifically, the controller 114 and the external power supply device, in correspondence with the acquired position of the running member 102.

Initial setting of the electric curtain device is performed using the switches 115 and the initial setting means, in accordance with, for example, the manipulation of the remote controller switch. In the initial setting, the external power supply device supplies the high frequency voltage at the first driving frequency to the running member 102. The running member 102 thus moves toward the right end 101g of the curtain rail 101. When the running member 102 reaches the right end 101g of the curtain rail 101, the corresponding one of the switches 115 contacts the right end 101g, such that an end reaching signal is generated. In response to the end reaching signal, the high frequency voltage at the second driving frequency is supplied to the running member 102, causing the running member 102 to move toward the left end 101h of the curtain rail 101. When the running member 102 reaches the left end 101h of the curtain rail 101, the other one of the switches 115 contacts the left end 101h, such that a different end reaching signal is generated. In response to the end reaching signal, the supply of the high frequency voltage is nullified.

While the running member 102 moves from the right end 101g to the left end 101h, or from when the first end reaching signal is generated to when the second end reaching signal is generated, the sensor magnet 111 rotates with the rotor 122 of the rotary member 109. This produces pulse data in the Hall element 113 in correspondence with the rotation of the sensor magnet 111. Further, rail length data based on the pulse data, or the pulse number corresponding to the length of the curtain rail 101, is set for the controller 114. Also, in correspondence with the rail length data, end positions of the curtain rail 101 and end vicinity positions 101i, 101j, each of which is spaced from the associated end position at a predetermined interval, are set for the controller 114. More specifically, based on the rail length data, the controller 114 acquires position data corresponding to the ends 101g, 101h of the curtain rail 101 and position data corresponding to the end vicinity positions 101i, 101j spaced from the associated end positions in accordance with a predetermined pulse number. FIG. 9 schematically indicates the rail length data, or the pulse number, in correspondence with the curtain rail 101 in a hypothetical manner.

When the running member 102 is moved from the stopped state toward the right end 101g or the left end 101h, the control means gradually changes the frequency of the high frequency voltage supplied to the supersonic motor 107, such that the frequency becomes closer to the first or second resonance frequency f101, f102 of the supersonic motor 107. Accordingly, the output of the supersonic motor 107 is gradually increased, thus preventing the output transmitting members 129 from being rotated idly before the running member 102 is started. Also, noise production is suppressed when the running member 102 is started. FIG. 9 shows the speed of the running member 102 when moving toward the right end 101g, or the curtain spreading speed, and the speed of the running member 102 when moving toward the left end 101h, or curtain folding speed. As is indicated by FIG. 9, when the running member 102 is started from the left end 101h toward the right end 101g, the moving speed of the running member 102 is gradually increased. Likewise, when the running member 102 is started from the right end 101g toward the end 101h, the moving speed of the running member 102 is gradually increased.

When the running member 102 is moved, the controller 114 of the position acquiring means computes and acquires the position of the running member 102 on the curtain rail 101 based on the pulse data. That is, the controller 114 computes and acquires the position data of the running member 102 on the curtain rail 101 in correspondence with the pulse number.

When determining that the running member 102 reaches one of the end vicinity positions 101i, 101j, the control means changes the frequency of the high frequency voltage supplied to the supersonic motor 107 away from the first or second resonance frequency f101, f102 of the supersonic motor 107. Accordingly, the output of the supersonic motor 107 is decreased, thus preventing the output transmitting members 129 from being rotated in an idle manner continuously after the running member 102 is stopped at the right end 101g or the left end 101h of the curtain rail 101. Also, impact or noise caused by the impact is suppressed when the running member 102 is stopped at the end 101g, 101h.

Further, in determining when the running member 102 reaches the end vicinity positions 101i, 101j, the control means supplies the high frequency voltage to the supersonic motor 107 for a predetermined time. The frequency of the voltage supply is changed away from the first or second resonance frequency f101, f102 of the supersonic motor 107. Thus, even if the control means falsely determines that the running member 102 reaches the right end 101g or the left end 101h due to a malfunction of the output transmitting member 129, for example, slight idle rotation of the output transmitting members 129, the running member 102 is thus prevented from being stopped before reaching the right end 101g or the left end 101h.

The second embodiment has the following advantages.

If the running member 102 reaches the right end 101g or the left end 101h of the curtain rail 101, the end reaching signal is generated by the contact between the end 101g, 101h and the corresponding switch 115. When the initial setting means initially moves the running member 102 from the right end 101g to the left end 101h of the curtain rail 101, the rail length data is set for the controller 114, or the position acquiring means, in correspondence with the end reaching signals. Setting of the rail length data is thus relatively easy and highly accurate. Accordingly, the position acquiring means is allowed to acquire the position of the running member 102 on the curtain rail 101 with improved accuracy. This also enhances the accuracy of operation of the control means based on the acquired position of the running member 102.

When the running member 102 is moved from the stopped state toward the right end 101g or the left end 101h, the control means changes the frequency of the high frequency voltage supplied to the supersonic motor 107 such that this frequency becomes closer to the first or second resonance frequency f101, f102 of the supersonic motor 107. The output of the supersonic motor 107 is thus gradually increased, preventing the output transmitting members 129 from being rotated idly when the running member 102 is started. Also, the noise caused by starting the running member 102 is suppressed. As a result, the running member 102 is prevented from erroneously operating or producing noise.

The runners 103 are arranged in the extending direction of the curtain rail 101 such that the runners 103 are rotatable about the vertical axis. Thus, referring to FIG. 8, the runners 103 are allowed to roll along the curved section 101f of the curtain rail 101. This permits the running member 102 to move smoothly along the curved section 101f in accordance with the shape of the curved section 101f.

The illustrated embodiments may be modified as follows.

In the first embodiment, the chargers 41 may be disposed at, for example, an intermediate portion of the curtain rail 101. In this case, it is necessary to change the configuration of the battery terminals 15a and the charging terminals 41a, through which the batteries 15 and the associated chargers 41 are electrically connected to each other. Alternatively, as long as each of the chargers 41 is arranged to charge the battery 15 located in the movement path of the corresponding running members 2a, 2b, the chargers 41 may be installed at, for example, a wall of a building. The movement path of the running members 2a, 2b extends between the chargers 41 of the first embodiment.

In the first embodiment, each charger 41 may be allowed to charge the associated battery 15 in response to a certain type of operation including manipulation of a remote controller switch and manual connection of the charger 41 to the battery 15.

In the first embodiment, the chargers 41 and the associated batteries 15 may be electrically connected to each other in a non-contact manner through, for example, magnetic induction charging. If this is the case, the charging terminals 41a and the battery terminals 15a can be eliminated, such that the appearance of the electric curtain device is further improved.

In the first embodiment, a solar battery (solar panel) 50 may be added to each of the running members 2a, 2b as shown in FIG. 5 for charging the associated battery 15. In this case, it is advantageous that each solar battery 50 is arranged to be exposed to sunlight from the rear side of the corresponding curtain 31, 32, or the side of the curtain 31, 32 corresponding to the window, or from the exterior of the window. The solar batteries 50 are thus allowed to charge the corresponding batteries 15, saving energy consumption of the electric curtain device. Also, even if each running member is located at a position at an intermediate position of the curtain rail 1 and the battery is away from the associated charger, the battery is charged by the corresponding solar battery. Thus, each battery 15 is prevented from becoming discharged.

In the first embodiment, each of the chargers 41 may be replaced by a solar battery for charging the corresponding battery 15. In this case, it is advantageous that each solar battery is located to be visible from the rear side of the corresponding curtain 31, 32, or the side of the curtain 31, 32 corresponding to the window, or from the exterior of the window. The solar batteries are thus allowed to charge the corresponding batteries 15. This structure makes it unnecessary to maintain each running member 2a, 2b as connected to an external power supply line.

In the first embodiment, the supersonic motor may be replaced by a different type of actuator such as a DC motor. If a DC motor is employed, the electric curtain device does not need the driver 16 for generating the high frequency voltage. Further, since DC motors are commonly used, cost for the electric curtain device is reduced.

In the first embodiment, the position acquiring means and the control means may be omitted. In this case, the frequency of the high frequency voltage supplied to each supersonic motor 7 becomes constant.

In the first embodiment, the curtain rail 1 may include a curved section. Since each support portion 4a is supported by the corresponding extended portion 4b to be rotatable about a vertical axis, the runner 3 is supported by the associated casing 5 to be rotatable about a vertical axis. Therefore, each running member 2a, 2b is capable of moving smoothly along the curved section of the curtain rail 1 in accordance with the shape of the curved section.

In the second embodiment, as long as the frequency of the high frequency voltage supplied to the supersonic motor 107 is changed in correspondence with the position of the running member 102, the position for changing the frequency is not restricted to the end vicinity positions 101i, 101j. For example, the control means may change the frequency of the voltage supply to the supersonic motor 107 away from the first or second resonance frequency f101, f102 of the supersonic motor 107, when determining the running member 102 reaches a predetermined position on the curved section 101f of the curtain rail 101. Also, such control regarding the curved section 101f may be added to the operation of the control means of the second embodiment.

In this manner, the output of the supersonic motor 107 is lowered when it is determined that the running member 102 reaches the predetermined position on the curved section 101f. The moving speed of the running member 102 is thus decreased from the curved section 10f. This reduces inertia force applied to the curtain rail 101 by the running member 102 and the curtain, or, more specifically, centrifugal force acting on the curtain rail 101. Accordingly, the curved section 101f is prevented from being deformed by such inertial force. Also, the curtain is prevented from temporarily swinging outward at the curved section 10f. In this case, it is necessary to detect the position of the curved section 101f, and the detected position of the curved section 101f needs to be inputted to the controller 114.

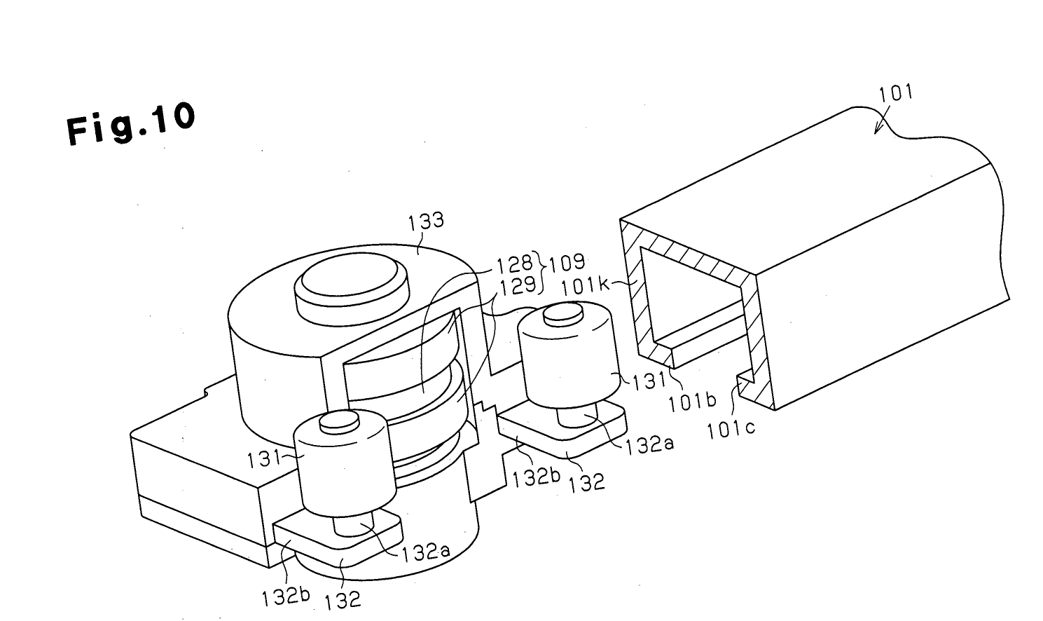

In the second embodiment, as shown in FIG. 10, two or more runners 131 may be arranged to be rollable along the curtain rail 101. The runners 131 laterally contact a vertical side section 101k of the curtain rail 101 for supporting the running member 102. In this case, the side section 101k of the curtain rail 101 is clamped between the runners 131 and the output transmitting members 129. Also, each connecting member 104 of the second embodiment is replaced by a connecting member 132 including a support pole 132a and an extended portion 132b. Each of the support poles 132a rotatably supports the corresponding one of the runners 131, which has a shape that is substantially cylindrical. Each of the extended portions 132b extends from the basal end of the associated support pole 132a in a manner bent at 90 degrees. Each extended portion 132b includes an accommodating recess 104c, like the extended portion 104b of the second embodiment.

Further, in the example of FIG. 14, the casing 105 of the second embodiment is replaced by a casing 133. The casing 133 is configured slightly different from the casing 105 of the second embodiment, such that the side section 101k of the curtain rail 101 is clamped between the runners 131 and the output transmitting members 129, or the runners 131 oppose the output transmitting members 129. The lower side of each runner 131 is supported by the corresponding support portion 101b, 101c of the curtain rail 101. Like the illustrated embodiments, this structure allows the runners 131 supporting the running member 102 to contact and roll along the curtain rail 101. Further, the runners 131 are allowed to roll along the curved section 101f, such that the running member 102 is moved smoothly along the curved section 101f in accordance with the shape of the curved section 101f.

In the second embodiment, setting of the rail length data may be conducted manually.

In the second embodiment, the running member 102 may be provided in an increased quantity for the curtain.

In the second embodiment, the curtain rail 101 may be shaped linearly. In this case, the support portion 104a of the connecting member 104 does not need to be supported by the extended portion 104b to be rotatable about a vertical axis.

In the first and second embodiments, the device of the present invention may be applied to a drive device that moves a different suspended member other than a curtain along a rail.

The present examples and embodiments are to be considered as illustrative and not restrictive and the invention is not to be limited to the details given herein, but may be modified within the scope and equivalence of the appended claims.

1. A drive device for a suspended member that is suspended from a rail, the drive device comprising:
a running member having an actuator, wherein the running member is movable along the rail and supports the suspended member in a suspended state, and wherein the running member is moved along the rail by drive force of the actuator;
a battery provided in the running member; and
a charger for charging the battery when the running member is at a location along a path of movement of the running member.

2. The device according to claim 1, wherein the charger is arranged at an end of the rail.

3. The device according to claim 1, wherein the charger is electrically connected to the battery for charging the battery when the running member is located in the vicinity of the charger, and wherein the charger is electrically disconnected from the battery when the running member is spaced from the charger.

4. The device according to claim 1, wherein the running member further include a solar battery for charging the battery.

5. The device according to claim 1, further comprising:
a rolling body that is capable of rolling on the rail; and
a rotary member, wherein the rotary member rotates while holding the rail between the rotary member and the rolling body, thereby causing the rolling body to roll on the rail.

6. The device according to claim 5, wherein the actuator is a supersonic motor, and the motor includes:
a stator for generating vibration when supplied with a high frequency voltage; and
a rotor that is pressed against the stator, the rotor rotating in correspondence with the vibration of the stator, wherein the rotor rotates integrally with the rotary member.

7. The device according to claim 6, wherein the running member further includes a driver for generating and supplying the high frequency voltage.

8. The device according to claim 6, further comprising:
a position acquiring means for acquiring the position of the running member on the rail; and
a control means for changing the frequency of the high frequency voltage supplied to the supersonic motor in correspondence with the position of the running member.

9. A drive device for a suspended member that is suspended from a rail, the drive device comprising:
a running member having an actuator, wherein the running member is movable along the rail and supports a suspended member in a suspended state, and wherein the running member is moved along the rail by drive force of the actuator;
a battery provided in the running member; and
a solar battery supported by the running member for charging the battery.

10. The device according to claim 9, further comprising:
a rolling body that is capable of rolling on the rail; and
a rotary member, wherein the rotary member rotates while holding the rail between the rotary member and the rolling body, thereby causing the rolling body to roll on the rail.

11. The device according to claim 10, wherein the actuator is a supersonic motor, and the motor includes:
a stator for generating vibration when supplied with a high frequency voltage; and
a rotor that is pressed against the stator, the rotor rotating in correspondence with the vibration of the stator, wherein the rotor rotates integrally with the rotary member.

12. The device according to claim 11, wherein the running member further includes a driver for generating and supplying the high frequency voltage.

13. The device according to claim 11, further comprising:
a position acquiring means for acquiring the position of the running member on the rail; and
a control means for changing the frequency of the high frequency voltage supplied to the supersonic motor in correspondence with the position of the running member.
